(19) United States
(12) Patent Application Publication
(10) Pub. No.: US 2013/0173907 A1
(43) Pub. Date: Jul. 4, 2013

(54) PKI GATEWAY

(71) Applicants: Sitaraman Suthamali Lakshminarayanan, Dunwoody, GA (US); Temidayo Temidoyo Yembra, Duluth, GA (US)

(72) Inventors: Sitaraman Suthamali Lakshminarayanan, Dunwoody, GA (US); Temidayo Temidoyo Yembra, Duluth, GA (US)

(73) Assignee: GENERAL ELECTRIC COMPANY, Schenectady, NY (US)

(21) Appl. No.: 13/343,536

(22) Filed: Jan. 4, 2012

(51) Int. Cl. H04L 29/06

(52) U.S. Cl. 713/153

(57) ABSTRACT

A PKI gateway allows an enterprise to maintain a limited number of PKI protocol interfaces while servicing every standard and proprietary PKI protocol used by a customer of the enterprise. The PKI gateway listens for a PKI management request, adds contextual information needed by the certificate authority, translates the request into the appropriate protocol, and executes the request.

### BACKGROUND OF THE INVENTION

The subject matter disclosed herein relates to the public key infrastructure.

Public Key Infrastructure (PKI) is a software infrastructure to create, manage, distribute, use, store, and revoke digital certificates used in the secure communication of data. Various standards exist for the implementation of PKI. For example, extensible markup language (XML) key management specification (XKMS) standards are typically used for any certificate management operation such as Issue, Revoke, Validate, Locate, and secure search, while the simple certificate enrollment protocol (SCEP) specifies how certificates can be enrolled. XKMS does not specify how certificates should be managed but, instead, provides format metadata or information about certificates that underlying PKI implementations use to manage issuing of certificates. The certificate management protocol (CMP) standards are also used for certificate operations including operations to obtain certificates. The use of any given standard by a client requires the enterprise communicating with that client to also adopt the standard in order to facilitate secure communication. The key management interoperability protocol (KMIP) is an attempt to establish a single comprehensive PKI protocol, but KMIP does not address the necessary life cycle management of existing and proprietary protocols.

### BRIEF DESCRIPTION OF THE INVENTION

According to one aspect of the invention, a public key infrastructure (PKI) gateway provides secure communication between an enterprise and one or more customers, the enterprise using a first set of protocols to communicate with the PKI gateway and the one or more customers using a second set of protocols to communicate with the PKI gateway. The PM gateway includes a protocol listener configured to listen for a PKI management request; a protocol translator configured to translate the request from a protocol among the first set of protocols to a protocol among the second set of protocols or from a protocol among the second set of protocols to a protocol among the first set of protocols; and a certificate management engine to ensure execution of the translated request.

According to another aspect of the invention, a method provides secure communication between an enterprise and one or more customers, the enterprise using a first set of protocols to communicate with a PKI gateway and the one or more customers using a second set of protocols to communicate with the PM gateway. The method includes listening for a PKI management request at the PKI gateway; translating the request from a protocol among the first set of protocols to a protocol among the second set of protocols or from a protocol among the second set of protocols to a protocol among the first set of protocols at the PKI gateway; and executing the translated request.

According to yet another aspect of the invention, a computer-readable medium stores a set of instructions which, when executed by a processor, cause the processor to perform a method of providing secure communication between an enterprise and one or more customers, the enterprise using a first set of protocols to communicate with a PKI gateway and the one or more customers using a second set of protocols to communicate with the PKI gateway. The method includes listening for a PKI management request at the PKI gateway; translating the request from a protocol among the first set of protocols to a protocol among the second set of protocols or from a protocol among the second set of protocols to a protocol among the first set of protocols at the PKI gateway; and executing the translated request.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a PKI infrastructure according to an embodiment of the invention;

FIG. 2 is a block diagram of the modules included in the PKI gateway; and

FIG. 3 illustrates the processes involved in operating a PKI gateway according to an embodiment of the invention.

### DETAILED DESCRIPTION OF THE INVENTION

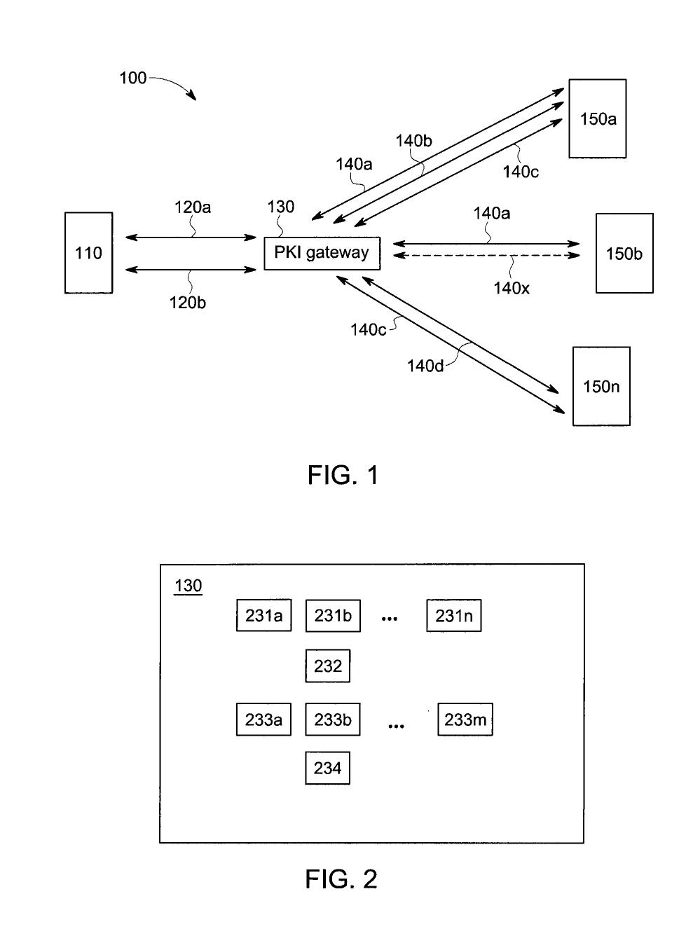

FIG. 1 illustrates a PKI system 100 according to an embodiment of the invention. As shown by FIG. 1, the enterprise 110 communicates with multiple customers 150 using multiple PKI standards 140. Because of the PKI gateway 130, the enterprise 110 can maintain a limited number of protocols 120 that it supports with each of its applications. The gateway 130 ensures that the ultimate output to the customers 150 is by whichever standard 140 is specified for the customer 150. When a customer (e.g., 150b) adds a new PKI standard (e.g., 140x), no changes are needed at the enterprise 110, because the new standard 140x is handled by the PKI gateway 130.

FIG. 2 is a block diagram of the modules included in the PKI gateway 130. The one or more memory devices and processors that implement the functionality of the PKI gateway 130 are not discussed herein but should be understood as being necessary for the implementation of any device that includes one or more software components. While components of the PKI gateway 130 are described as separate modules, a single component with the requisite memory and processors in contemplated as well as multiple components with their own memory devices and processors. The PKI gateway 130 includes a protocol listener 231 for each PM standard supported by the PKI gateway 130, a PKI context engine 232, protocol translator 233 for each PKI standard supported by the PKI gateway 130, and a certificate management engine 234.

The exemplary protocol listeners 231 may be an SCEP listener (231a), a KMIP listener (231b), and an XKMS listener (231c). The protocol listeners listen for a PKI management request such as a request to issue, validate, or revoke a certificate from customers 150. The PKI context engine 232 authenticates and authorizes requests and does additional encryption or integrity verification. The PKI context engine 232 may add context in the form of additional details about requests and responses that are not known or needed on the enterprise 110 side or the customer 150 side but that are needed by the PM certificate authority. For example, during a Locate Request, the enterprise 110 may send an input request to the PKI gateway 130 that includes data such as Domain Name System (DNS) name or email address. The PKI gateway 130 may add additional data to form an SCEP request that is then sent to a PKI Infrastructure element. During its Initial Register requests process, the PKI gateway 130 may have created unique Identifiers (Certificate Identifier) that are stored in the PKI gateway 130 for this purpose.

Each protocol translator 233 indicates a pair of translators. That is, for example, protocol translator 233a indicates a translator from a customer PKI standard 140a to one of the enterprise protocols 120a and also from the enterprise protocol 120a to the customer PKI standard 140a. The addition of a new customer standard (e.g., 140x) requires that a translator 233 pair be added for each enterprise protocol (one translator pair to translate from standard 140x to 120a and from 120a to 140x and another translator pair to translate from standard 140x to 120b and from 120b to 140x). Even if a PM standard (e.g., 140x) is new to a given customer 150, if the translator 233 pair is part of the PKI gateway 130 because another customer 150 does or did use that same standard, a new protocol translator 233 pair need not be added to the PKI gateway 130. A technical effect is that through the inclusion of protocol translators 233 in the PKI gateway 130, the enterprise 110 need not adopt every customer 150 PKI solution for every software solution and device. The translation necessary for a given transaction between the enterprise 110 and a customer 150 is provided to the PKI gateway 130 as a predetermined selection or determination of a rule.

The certificate management engine 234 uses an underlying PKI application programming interface (API) or service to execute the operations related to the translated requests received at the PKI gateway 130. In the absence of an underlying PKI solution, the certificate management engine 234 uses a default standard implementation such as CMP or SCEP and itself acts as the certificate authority. For example, not every customer 150 may have PKI Infrastructure. In that case, the PKI gateway 130 could include basic PKI Functionality supported by the SCEP standard. The default standard implementation could be a home-grown solution or could use an Open-source PKI Server such as Open CA.

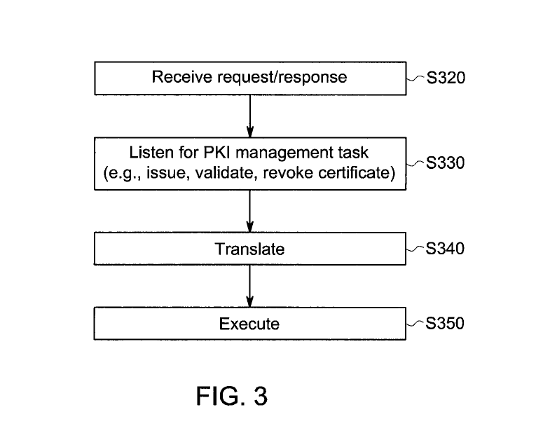

FIG. 3 illustrates the processes involved in operating a PKI gateway 130 according to an embodiment of the invention. At S320, receiving a request or response includes receiving communication from the enterprise 110 or any of the customers 150. At block S330, listening includes examining the incoming communication to determine if any PKI management requests were received. PKI management requests include request for the issuance, validation, or revocation of a PKI certificate. A received request is readied for the other side of the PKI gateway 130 (for the enterprise 110 if received from a customer 150 or for a customer 150 if received from the enterprise 110) by translating at S340. The translating at S340 includes having predetermined knowledge of the PKI standard 140 being used by the customer 150 and the protocol 120 being used by the enterprise 110 for the particular transaction. At S350, executing includes executing a translated request with an underlying PKI API or, in the absence of an existing PKI solution, the PKI gateway 130 acting as the certificate authority using a default standard PKI implementation.

Elements of the embodiments have been introduced with either the articles “a” or “an.” The articles are intended to mean that there are one or more of the elements. The term “including” is intended to be inclusive such that there may be additional elements other than those elements listed. The conjunction “or,” when used with a list of at least two terms, is intended to many any term or combination of terms.

It will be recognized that the various components and technologies may provide certain necessary or beneficial functionality or features. Accordingly, these functions and features as may be needed in support of the appended claims and variations thereof are recognized as being inherently included as part of the teachings herein and a part of the invention disclosed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A public key infrastructure (PKI) gateway to provide secure communication between an enterprise and one or more customers, the enterprise using a first set of protocols to communicate with the PKI gateway and the one or more customers using a second set of protocols to communicate with the PKI gateway, the PKI gateway comprising:
a protocol listener configured to listen for a PKI management request;
a protocol translator configured to translate the request from a protocol among the first set of protocols to a protocol among the second set of protocols or from a protocol among the second set of protocols to a protocol among the first set of protocols; and
a certificate management engine to ensure execution of the translated request.

2. The gateway according to claim 1, further comprising:
a context engine configured to add information to the request.

3. The gateway according to claim 1, wherein the first set of protocols includes one or more protocols including extensible markup language (XML) key management specification (XKMS).

4. The gateway according to claim 1, wherein the first set of protocols includes one or more protocols key management interoperability protocol (KMIP).

5. The gateway according to claim 1, wherein the certificate management engine executes the translated request using an existing PKI service.

6. The gateway according to claim 1, wherein the certificate management engine acts as a certificate authority to execute the translated request.

7. A method of providing secure communication between an enterprise and one or more customers, the enterprise using a first set of protocols to communicate with a PKI gateway and the one or more customers using a second set of protocols to communicate with the PKI gateway, the method comprising:
listening for a PKI management request at the PKI gateway;
translating the request from a protocol among the first set of protocols to a protocol among the second set of protocols or from a protocol among the second set of protocols to a protocol among the first set of protocols at the PKI gateway; and
executing the translated request.

8. The method according to claim 7, further comprising:
adding context details to the request.

9. The method according to claim 7, wherein the translating includes translating the request from one of the one or more customers from a protocol among the second set of protocols to extensible markup language (XML) key management specification (XKMS).

10. The method according to claim 7, wherein the translating includes translating the request from one of the one or more customers from a protocol among the second set of protocols to key management interoperability protocol (KMIP).

11. A computer-readable medium configured to store a set of instructions which, when executed by a processor, cause the processor to perform a method of providing secure communication between an enterprise and one or more customers, the enterprise using a first set of protocols to communicate with a PKI gateway and the one or more customers using a second set of protocols to communicate with the PKI gateway, the method comprising:
listening for a PKI management request at the PKI gateway;
translating the request from a protocol among the first set of protocols to a protocol among the second set of protocols or from a protocol among the second set of protocols to a protocol among the first set of protocols at the PKI gateway; and
executing the translated request.

12. The medium according to claim 11, wherein the method further comprises adding context details to the request.

13. The medium according to claim 11, wherein the translating includes translating the request from one of the one or more customers from a protocol among the second set of protocols to extensible markup language (XML) key management specification (XKMS).

14. The method according to claim 11, wherein the translating includes translating the request from one of the one or more customers from a protocol among the second set of protocols to key management interoperability protocol (KMIP).
